(19) United States
(12) Patent Application Publication
(10) Pub. No.: US 2009/0284863 A1
(43) Pub. Date: Nov. 19, 2009

(54) MAGNETIC RECORDING CIRCUIT, MAGNETIC RECORDING DEVICE, AND INFORMATION RECORDING METHOD

(75) Inventor: Hiroshi Uno, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/510,711

(22) Filed: Jul. 28, 2009

Related U.S. Application Data
(63) Continuation of application No. PCT/JP2007/055492, filed on Mar. 19, 2007.

(51) Int. Cl. G11B 21/02

(52) U.S. Cl. 360/75; G9B/21.003

(57) ABSTRACT

A magnetic recording circuit includes a write amplifier that supplies a recording current to a magnetic recording head, and switches a direction of the recording current in accordance with information. The magnetic recording circuit further includes a control circuit that adjusts a rising speed of the recording current.

### CROSS-REFERENCE TO RELATED APPLICATION

This is a continuation application of PCT/JP2007/55492, filed on Mar. 19, 2007.

### FIELD

The embodiments discussed herein are directed to a magnetic recording device with a magnetic recording medium and a magnetic recording head that records information on the magnetic recording medium in accordance with a recording current, a magnetic recording circuit that supplies the recording current to the magnetic recording head, and an information recording method implemented in the magnetic recording device.

### BACKGROUND

Conventionally, magnetic recording devices are used as memory devices in computers. In recent years, however, magnetic recording devices are used in a wider range of fields, being incorporated into video cameras, car navigation systems, and the like.

FIG. 1 is a schematic view illustrating an example of the structure of a magnetic recording device.

The magnetic recording device 10 includes a disk-like magnetic recording medium 12 that is rotated in the direction of an arrow A about a rotation axis 11 by a disk control motor (DCM) that is not illustrated in FIG. 1.

The magnetic recording device 10 also includes an arm 15 and a voice coil motor (VCM) 16. The arm 15 has a magnetic head 13 (see FIG. 2) facing the magnetic recording medium 12 and attached to a tip of the arm 15, and rotates about a rotation axis 14. The voice coil motor 16 drives the arm 15 to make the arm 15 swing so that the magnetic head 13 moves in the radial direction of the magnetic recording medium 12. The magnetic recording device 10 also includes an activated-carbon desiccant unit (AD unit) 17 for maintaining a dry air in the device.

The magnetic recording device 10 further includes a ramp 18 that holds the tip of the arm 15 at the time of unloading.

When information is to be written onto the magnetic recording medium 12 or information stored in the magnetic recording medium 12 is to be read out, the arm 15 is rotatively driven by the DCM 16, as the magnetic recording medium 12 is rotated by the DCM 16. The arm 15 detached from the ramp 18 illustrated in FIG. 1, and the magnetic head 13 attached to the tip of the arm 15 moves (or is loaded) onto the magnetic recording medium 12. The magnetic head 13 is then positioned at a desired track on the magnetic recording medium 12. Information is magnetically and sequentially written onto or picked up from the desired track on the magnetic recording medium 12 by the magnetic head 13, as the magnetic recording medium 12 is being rotated. When the writing onto the magnetic recording medium 12 or the reading from the magnetic recording medium 12 is finished, the arm 15 is unloaded and again held by the ramp 18 as illustrated in FIG. 1.

FIG. 2 is a schematic view illustrating the structure of the tip of the arm 15 illustrated in FIG. 1.

The arm 15 has a carriage 151 that extends from the rotation axis of the arm 15, and a suspension 152 that extends from a front end of the carriage 151, with a rear end of the suspension 152 being attached to the tip of carriage 151. The magnetic head 13 is attached to the front end of the suspension 152. The magnetic head 13 has a gimbal part 131 that is swingably attached to the front end of the suspension 152, and a slider 132 supported by the gimbal part 131.

When the arm 15 is loaded onto the magnetic recording medium 12, the slider 132 floats very slightly above the magnetic recording medium 12. The magnetic head 13 having the slider 132 attached thereto writes data onto the magnetic recording medium 12 or reads data from the magnetic recording medium 12.

FIG. 3 is a schematic view illustrating the structure of a recording head 130 that is a part of the magnetic head and records information onto the magnetic recording medium. FIG. 4 illustrates a waveform of a recording current to be applied to the coil of the recording head 130 illustrated in FIG. 3.

As illustrated in FIG. 3, the recording head 130 conventionally has a ring-like head formed with a yoke 131 and a coil 132.

The recording current illustrated in FIG. 4 is applied to the coil 132, and a magnetic field induced by the recording current passes through the yoke 131. As a result, a magnetic field 134 is generated by a gap 133, as illustrated in FIG. 4. In this manner, the magnetic recording medium 12 is magnetized. Conventionally, as the current increase rate of the recording current waveform illustrated in FIG. 4 becomes higher, or as the crest and trough of the recording current waveform are steeper, the recording transition width on the magnetic recording medium becomes smaller. Therefore, the electromagnetic conversion characteristics are measured, with a set value Iw and the overshoot amount of the recording current being varied, so as to adjust the set value Iw of the recording current and the overshoot amount so that a signal level at the time of reading and an overwrite characteristics value (O/W) that is an evaluated value of the characteristics in erasing recorded information are optimized. As a result, the recording current applied to the recording head has an overshoot amount twice to three times as large as the set value Iw of the recording current, as illustrated in FIG. 4. This is because it is necessary to generate a larger recording magnetic field, as the recording density becomes higher.

In a case of a complex-type head that has a magnetoresistive head as a reproduction head for reading information recorded on a magnetic recording medium, a recording head and the reproduction head are placed at locations adjacent to each other but are formed separately from each other. Accordingly, the recording head is designed for recording only, and the overwrite characteristics are improved by increasing the gap length “a” and expanding the generated magnetic field even deeper, with no reproducing operations being taken into consideration. When this type of recording that utilizes overshoot is employed, a leakage magnetic field acts on neighboring tracks due to the large recording magnetic field and the large gap length “a”. As a result, there occurs a side erase phenomenon in which information recorded on the neighboring tracks is erased little by little. To address this problem, it is necessary to form a wide buffer region between the target track and the adjacent tracks. However, such a wide buffer region is a serious hindrance to an increase in TPI (the number of tracks per inch) that represents the recording density in the radial direction. Also, the current generated at an overshoot peak causes crosstalk with the reproduction head located in an adjacent position, and the crosstalk causes the reproduction head to deteriorate, as the reproduction head is very sensitive to voltage application.

As a conventional technique, a circuit that controls overshoot amplitude and width separately from each other is proposed in Japanese Laid-open Patent Publication No. 2006-164312. Also, as another conventional technique, a circuit for improving the rise characteristics of a recording current is proposed in Japanese Laid-open Patent Publication No. 11-283202.

However, Japanese Laid-open Patent Publications No. 2006-164312 and No. 11-283202 merely describe circuits that control the overshoot amount and the rise characteristics of the recording current waveform illustrated in FIG. 4, and do not suggest any technique for improving the overwrite characteristics while preventing a side erase phenomenon and crosstalk with the reproduction head by reducing the overshoot of the recording current.

### SUMMARY

According to an aspect of the invention, a magnetic recording circuit includes:

a write amplifier that supplies a recording current to a magnetic recording head, and switches a direction of the recording current in accordance with information; and

a control circuit that adjusts a rising speed of the recording current.

According to another aspect of the invention, a magnetic recording device includes:

a magnetic recording medium which magnetically stores information and whose rotation is controlled;

a magnetic recording head that magnetically records information onto the magnetic recording medium in accordance with a recording current, and is movable in a radial direction of the magnetic recording medium; and

a control section that adjusts a rising speed of the recording current.

According to another aspect of the invention, an information recording method includes:

adjusting a rising speed of a recording current when the information recording method is implemented in a magnetic recording device that includes: a magnetic recording medium which magnetically stores information and whose rotation is controlled; and a magnetic recording head that magnetically records information onto the magnetic recording medium in accordance with the recording current, and is movable in a radial direction of the magnetic recording medium.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic view illustrating an example of the structure of a magnetic recording device;

FIG. 2 is a schematic view illustrating the structure of the tip of an arm illustrated in FIG. 1;

FIG. 3 is a schematic view illustrating the structure of a recording head that is a part of a magnetic head and records information onto a magnetic recording medium;

FIG. 4 illustrates a waveform of a recording current to be applied to a coil of the recording head illustrated in FIG. 3;

FIG. 5 illustrates a change in a write bubble with time;

FIG. 6 illustrates a recording current waveform;

FIG. 7 is a block diagram of an information recording circuit of a magnetic recording device in accordance with an embodiment of the present invention;

FIG. 8 is a circuit diagram of a write amplifier, an Iw current supply, and a slew rate varying circuit illustrated in the block diagram in FIG. 7;

FIG. 9 is a timing chart illustrating the operation of the circuit illustrated in FIG. 8;

FIG. 10 illustrates recording currents having various rising speeds in an overlapping manner;

FIG. 11 illustrates electromagnetic conversion characteristics of a read level observed when the set value Iw and the rising speed of a recording current are used as parameters; and

FIG. 12 illustrates electromagnetic conversion characteristics of overwrite characteristics observed when the set value Iw and the rising speed of a recording current are used as parameters.

### DESCRIPTION OF EMBODIMENTS

In the following, the relationship between the relative velocity of the magnetic recording medium with respect to the recording head and the influence of the magnetic field generated from the recording head on the magnetic recording medium will be described first, and embodiments of the present invention will then be described.

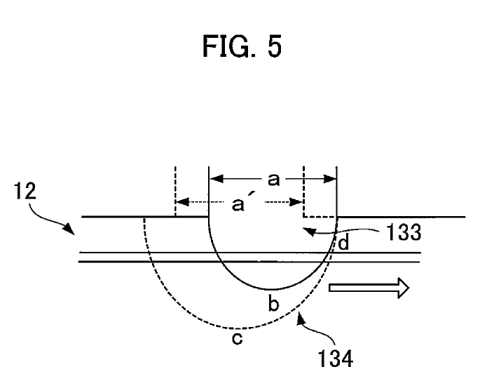

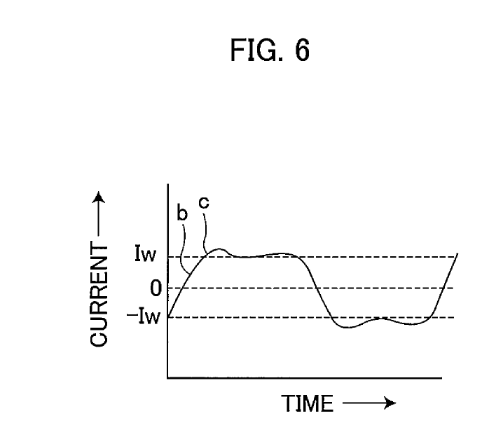

FIG. 5 illustrates a change in a write bubble with time, and FIG. 6 illustrates a recording current waveform.

It is known that the requisites for magnetizing the magnetic recording medium 12 are determined by the strength φ of a magnetic field acting on the magnetic recording medium 12 and the time τ during which the magnetic field is effective. Accordingly, the strength φ of the magnetic field may be small, if the time τ is made longer. When a recording current having the waveform illustrated in FIG. 6 is applied to a recording head, the magnetic field 134 illustrated in FIG. 5 generated through the gap 133 having a gap length “a” acts on the magnetic recording medium 12. At a point “b” in the middle of the rise of the recording current in FIG. 6, the magnetic field represented by a curve “b” in FIG. 5 is generated. A curve like the curve “b” connecting the points at which the strength of the magnetic field is constant is called a “write bubble.” When the recording current increases further and reaches a point “c” illustrated in FIG. 6, the magnetic recording medium moves in the direction indicated by an arrow in FIG. 5, while the recording waveform changes from the point “b” to the point “c” illustrated in FIG. 6. As a result, the gap 133 of the recording head relatively moves to the position of a gap length a′ illustrated in FIG. 5, and the magnetic field having the same length as the constant strength curve (write bubble) “b” of the magnetic field generated at the point “b” illustrated in FIG. 6 expands and becomes as large as the curve (write bubble) “c”. The expansion speed of the write bubble varies directly with the rising speed of the recording current. Meanwhile, the magnetic recording medium moves at constant speed in the direction indicated by the arrow. The movement speed of the disk-like rotating magnetic recording medium is determined by the rotation speed and the radius r of the recording target track from the center of rotation.

Here, the movement speed of the magnetic recording medium 12 and the expansion speed of the write bubble from the recording head are maintained at constant values as long as possible, so as to maximize the time τ during which magnetic fields of the same strength act on the curve “b” and the curve “c” at the point “d” on the magnetic recording medium. As a result, the magnetic recording medium can be sufficiently magnetized even with magnetic fields of small strength φ.

The expansion speed of the write bubble can also be varied by changing the set value Iw of the recording current illustrated in FIG. 6. If the Iw value is made larger, the expansion speed of the write bubble becomes higher. To obtain a high-speed circuit, however, there is a limit to varying the expansion speed of the write bubble in a sufficient range by changing the Iw value, and it is preferable to actively control the rise characteristics of the recording current.

Accordingly, the time τ may be maximized on the entire region of the magnetic recording medium by varying the rising speed of the recording current in accordance with the relative velocity of the magnetic recording medium with respect to the recording head, thereby improving the overwrite characteristics while restricting a side erase phenomenon and crosstalk to small amounts.

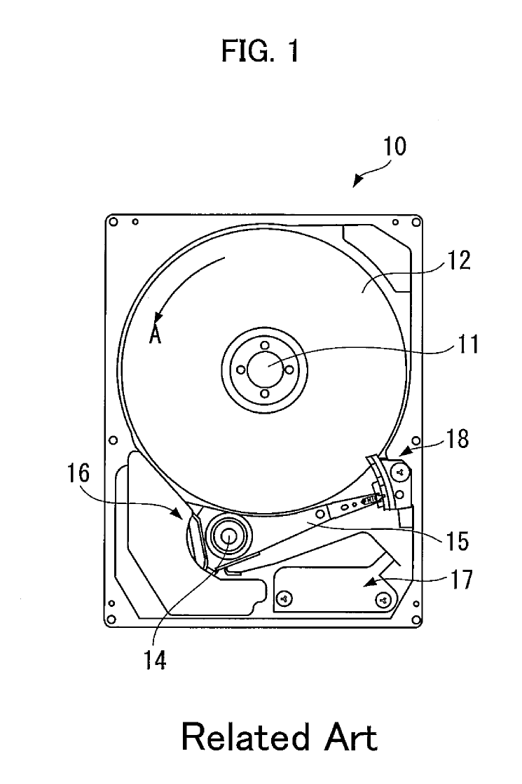

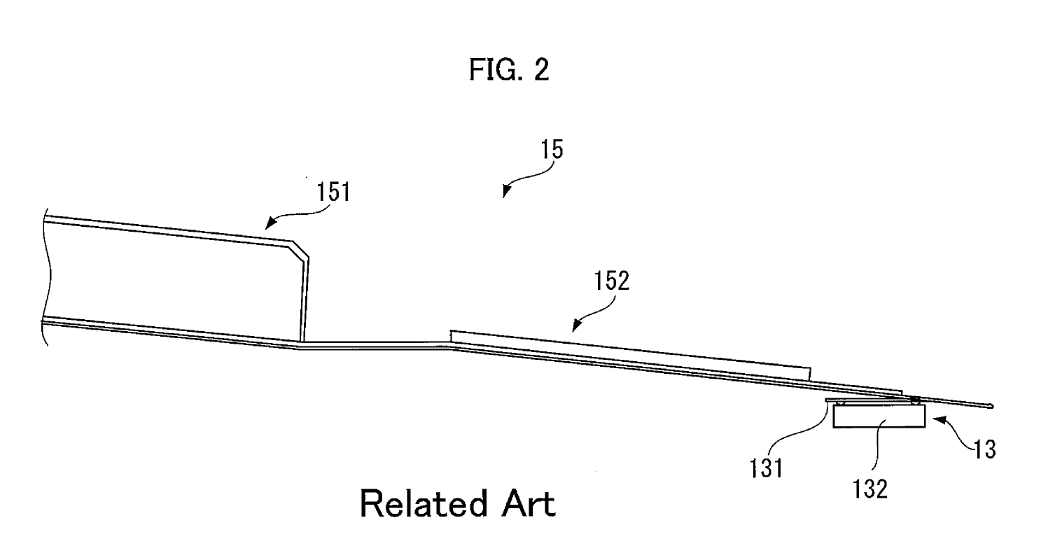

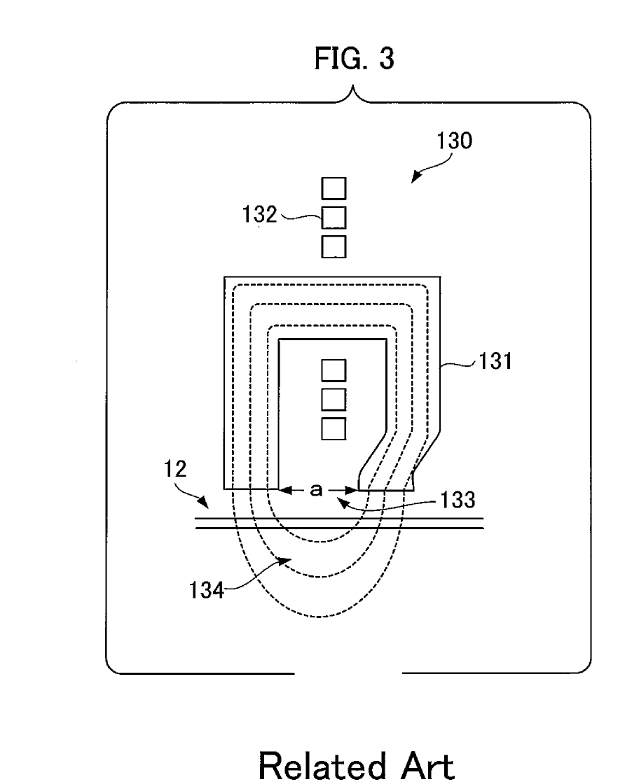

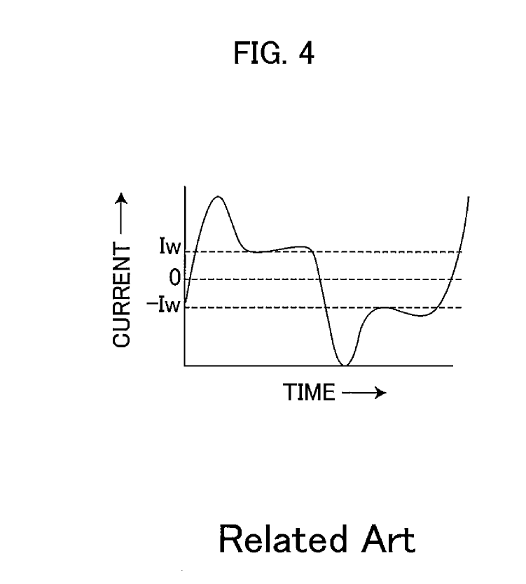

Next, an embodiment of the present invention will be described. The structure of a magnetic recording device serving as an embodiment of the present invention is the same as the conventional example illustrated in FIGS. 1 and 2. Therefore, description of the overall structure will be not repeated here, and only a circuit structure unique to the magnetic recording device of this embodiment will be described. It should be noted that the description of the operation of this magnetic recording device also covers an embodiment of an information recording method according to the present invention.

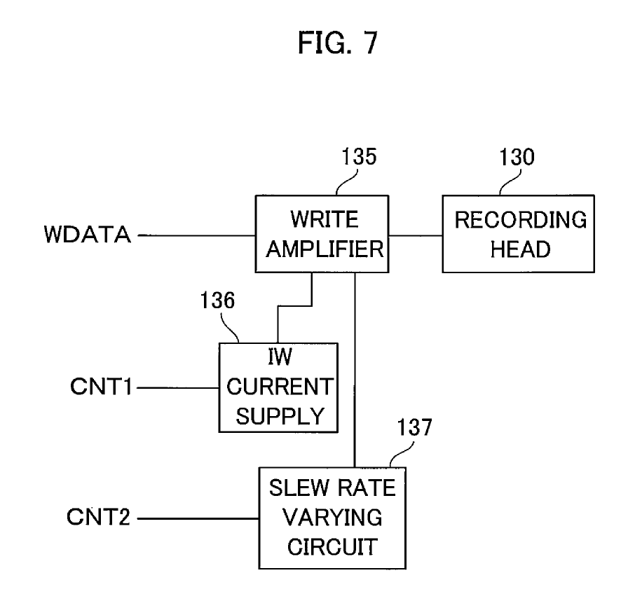

FIG. 7 is a block diagram of the information recording circuit of the magnetic recording device in accordance with the embodiment of the present invention.

In this example, data to be written is input from outside, and is converted at a circuit in a previous stage (not illustrated) into write data WDATA in a format for input to a write amplifier 135. After the conversion, the write data WDATA is input to the write amplifier 135. The write amplifier 135 applies a recording current input from an Iw current supply 136 to a recording head 130, after changing the direction of the current in accordance with the write data WDATA. The recording head 130 is included in the magnetic head 13 illustrated in FIG. 2 and serves to write data. When the write amplifier 135 applies the recording current to the recording head 130, the input write data WDATA is converted into the recording current that has the current value of the current supplied from the Iw current supply 136 and rises at the rising speed determined by a slew rate varying circuit 137, and the recording current is then applied to the recording head 130. Control signals CNT1 and CNT2 are input from the circuit at the previous stage (not illustrated) to the Iw current supply 136 and the slew rate varying circuit 137. The control signals CNT1 and CNT2 are determined by the movement speed of the track of the rotating magnetic recording medium on which the write data WDATA is about to be written (the movement speed being a function of the radius r of the track from the center of rotation of the magnetic recording medium). At the Iw current supply 136, the set value Iw of the recording current is adjusted in accordance with the control signal CNT1. At the slew rate varying circuit 137, the rising speed of the recording current is adjusted in accordance with the control signal CNT2. Particularly, at the slew rate varying circuit 137, the rising speed of the recording current is set and adjusted in accordance with the control signal CNT2, so that the recording current rises at a higher speed, as the radius r of the track on which the write data WDATA is about to be written is greater from the center of rotation, or the relative velocity of the track of the magnetic recording medium with respect to the recording head 130 is higher.

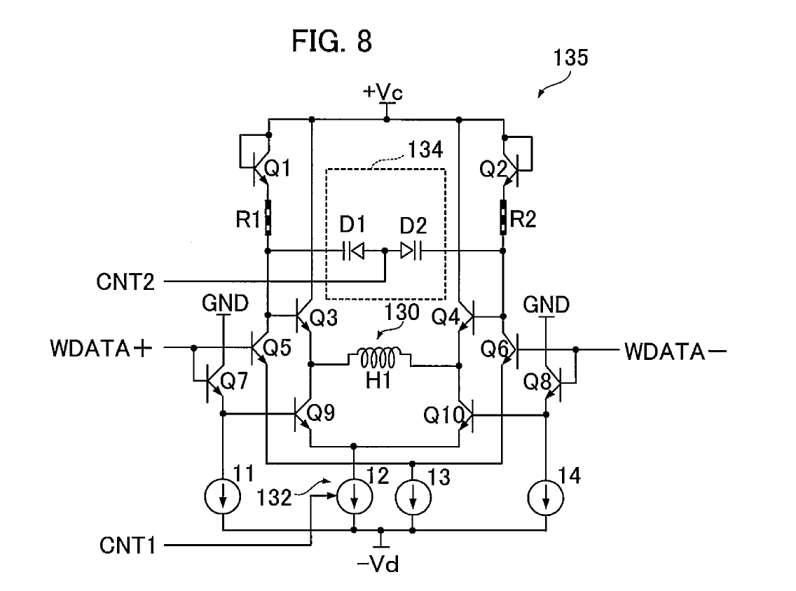

FIG. 8 is a circuit diagram of the write amplifier, the Iw current supply, and the slew rate varying circuit illustrated in the block diagram in FIG. 7.

The circuit illustrated in FIG. 8 is a circuit that operates with the two power supplies: a positive power supply +Vc and a negative power supply −Vd. In this circuit, H1 represents the coil of the magnetic head 130, R1 and R2 represent resistances, and D1 and D2 represent variable capacity diodes. The variable capacity diodes D1 and D2 constitute the slew rate varying circuit 134. The resistance formed with a diode-connected NPN transistor Q1, the resistance R1, and the variable capacity diode D1 constitute a time constant circuit. Likewise, the resistance formed with a diode-connected NPN transistor Q2, the resistance R2, and the variable capacity diode D2 constitute a time constant circuit. The capacity values of the variable capacity diodes D1 and D2 are controlled by the control signal CNT2, and the time constant varies accordingly. A recording current having a rising speed corresponding to the time constant is applied to the coil H1.

I1, I2, I3, and I4 represent current supplies, and the current supply I2 has its current value controlled by the control signal CNT1. The current value of the current flowing in the current supply I2 is equal to the current value observed after the rising of the recording current flowing in the coil H1, and the current supply I2 is equivalent to the Iw current supply 132 of FIG. 7. The remaining parts of the circuit illustrated in FIG. 8, the variable capacity diodes D1 and D2, and the current supply I2 constitute the write amplifier 135. In the circuit illustrated in FIG. 8, Q1 through Q10 represent NPN transistors, and the two NPN transistors Q1 and Q2 of the NPN transistors Q1 through Q10 are diode-connected as mentioned above. GND represents a ground potential.

The write data WDATA is input to the write amplifier 135 as a positive (+) complementary signal and a negative (−) complementary signal. An example case where the complementary signal WDATA+ transits from the H level to the L level while the complementary signal WDATA− transits from the L level to the H level will be described here. Before the transition, the NPN transistors Q3, Q6, and Q10 are in a cut-off state, and the NPN transistors Q4, Q5, and Q9 are in a conductive state. At the time of the transition, the states of those NPN transistors are reversed. Accordingly, the NPN transistors Q3, Q6, and Q10 transit to a conductive state, and the NPN transistors Q4, Q5, and Q9 transit to a cut-off state. Before the transition, the current in the coil H1 flows from the NPN transistor Q4 to the coil H1, to the NPN transistor Q9, to the current supply I2. After the transition, the current in the coil H1 flows from the NPN transistor Q3 to the coil H1, to the NPN transistor Q10, to the current supply I2. When the current paths are switched, the flowing directions of the recording current are switched at the rising (and falling) speed corresponding to the time constant of the time constant circuit. The same applies to a case where WDATA− transits from the H level to the L level while WDATA+ transits from the L level to the H level. At the time of the transition, the recording current flowing in the coil H1 is again reversed at the rising speed corresponding to the time constant of the time constant circuit.

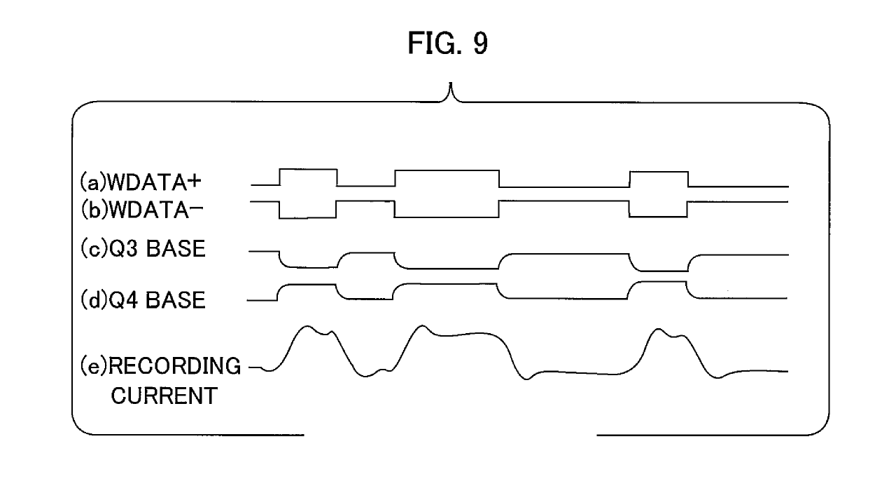

FIG. 9 is a timing chart illustrating the operation of the circuit illustrated in FIG. 8.

When the write data WDATA+ and WDATA− as complementary signals vary as illustrated in parts (a) and (b) of FIG. 9, the base currents of the NPN transistors Q3 and Q4 vary at the speed corresponding to the time constant of the time constant circuit as illustrated in parts (c) and (d) of FIG. 9, and the recording current having its rising speed adjusted as illustrated in part (e) of FIG. 9 is applied.

When the voltage value of the control signal CNT2 illustrated in FIGS. 7 and 8 is changed, the capacities of the variable capacity diodes D1 and D2 vary, and the time constant varies accordingly. As a result, the rising speed of the recording current flowing in the coil H1 of the recording head 13 varies.

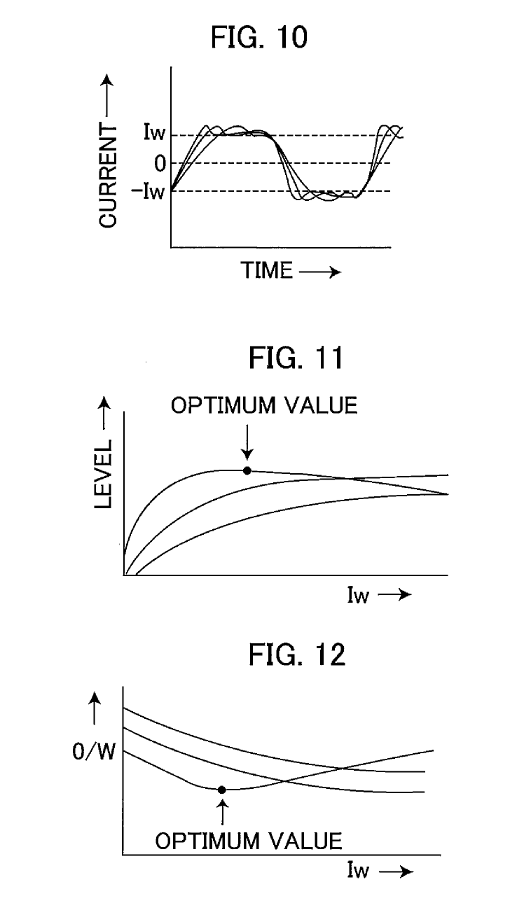

FIG. 10 illustrates recording currents having various rising speeds in an overlapping manner. In FIG. 10, recording current waveforms having small overshoots are illustrated. When the capacity values of the variable capacity diodes D1 and D2 are made smaller, the time constant becomes smaller, and the rising speed of the recording current becomes higher. When the capacity values of the variable capacity diodes D1 and D2 are made larger, the time constant becomes larger, and the rising speed of the recording current becomes lower.

FIG. 11 illustrates the electromagnetic conversion characteristics of the read level observed when the set value Iw and the rising speed of the recording current are used as parameters. FIG. 12 illustrates the electromagnetic conversion characteristics of the overwrite characteristics observed when the set value Iw and the rising speed of the recording current are used as parameters.

In FIGS. 11 and 12, the relative velocity of the magnetic recording medium with respect to the recording head is fixed, and one of the curves is a curve obtained when the rising speed is fixed and the recording current Iw is varied. In other words, the data illustrated in FIGS. 11 and 12 are obtained by determining the read levels (FIG. 11) and the overwrite characteristic values (FIG. 12) when the relative velocity and the rising speed are fixed while the recording current Iw is varied, and repeating the same determining process with various rising speeds.

In FIG. 11, the highest read level is desirable. In FIG. 12, the smallest overwrite characteristic value is desirable.

As the rising speed of the recording current is gradually varied, the optimum value is found in both the read level and the overwrite characteristics when the recording current Iw is small.

The optimum value of the read level and the optimum value of the overwrite characteristics do not precisely correspond to each other, but exist close to each other. With the two optimum values being taken into consideration, the recording current is set. Only the data obtained at a certain relative velocity is illustrated in this example. However, in a case where the relative velocity is varied, optimum values are obtained with a smaller recording current, when it is set that the higher the relative velocity is, the higher the rising speed of the recording current is.

By optimizing the rising speed of the recording current in accordance with the relative velocity, a high read level and low overwrite characteristics are achieved with a small recording current. Also, since the recording current is made small, a side erase phenomenon is prevented, and the reproduction head is prevented from deteriorating due to crosstalk of the reproduction head.

As described above, the present invention improves overwrite characteristics while preventing a side erase phenomenon and crosstalk.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A magnetic recording circuit comprising:
a write amplifier that supplies a recording current to a magnetic recording head, and switches a direction of the recording current in accordance with information; and
a control circuit that adjusts a rising speed of the recording current.

2. The magnetic recording device according to claim 1, wherein the control circuit has a variable capacity diode.

3. A magnetic recording device comprising:
a magnetic recording medium which magnetically stores information and whose rotation is controlled;
a magnetic recording head that magnetically records information onto the magnetic recording medium in accordance with a recording current, and is movable in a radial direction of the magnetic recording medium; and
a control section that adjusts a rising speed of the recording current.

4. The magnetic recording device according to claim 3, wherein the control section has a variable capacity diode.

5. The magnetic recording device according to claim 3, wherein the control section reduces the rising speed of the recording current when the magnetic recording head is at an inner circumferential location on the magnetic recording medium, and increases the rising speed of the recording current when the magnetic recording head is at an outer circumferential location on the magnetic recording medium.

6. An information recording method comprising:
adjusting a rising speed of a recording current when the information recording method is implemented in a magnetic recording device that includes: a magnetic recording medium which magnetically stores information and whose rotation is controlled; and a magnetic recording head that magnetically records information onto the magnetic recording medium in accordance with the recording current, and is movable in a radial direction of the magnetic recording medium.

7. The information recording method according to claim 6, wherein adjusting the recording current by electromagnetic conversion characteristics with changing the rising speed.

8. The information recording method according to claim 6, wherein the adjusting the rising speed includes:
reducing the rising speed of the recording current when the magnetic recording head is at an inner circumferential location on the magnetic recording medium; and
increasing the rising speed of the recording current when the magnetic recording head is at an outer circumferential location on the magnetic recording medium.
